(19) United States
(12) Patent Application Publication
(10) Pub. No.: US 2025/0231592 A1
(43) Pub. Date: Jul. 17, 2025

(54) ELECTRONIC DEVICE AND HINGE MODULE WITH MULTIMEDIA ASSEMBLY THEREOF

(71) Applicant: Wistron Corporation, New Taipei City (TW)

(72) Inventors: Chung-Jung WU, New Taipei City (TW); Li-Xuan SUN, New Taipei City (TW)

(21) Appl. No.: 18/611,801

(22) Filed: Mar. 21, 2024

(30) Foreign Application Priority Data
Jan. 15, 2024 (TW) 113101603

(51) Int. Cl. G06F 1/16; E05D 3/02; F16C 11/04

(52) U.S. Cl. CPC G06F 1/1681; F16C 11/04; E05D 3/02; E05Y 2999/00

(57) ABSTRACT

An electronic device and a hinge module with a multimedia assembly thereof are provided. The electronic device includes a first body, a second body, and a hinge module. The hinge module is located on one side of the first body. The hinge module includes a main shaft member, a transmission assembly, and a multimedia assembly. The main shaft member is pivotally connected to the first body and the second body. The transmission assembly is rotatably connected to the main shaft member. The multimedia assembly is connected to the transmission assembly. The multimedia assembly is used to rotate relative to the first body and the second body through the main shaft member. A rotation direction of the multimedia assembly is opposite to a rotation direction of the main shaft member.

### CROSS-REFERENCE TO RELATED APPLICATION

This non-provisional application claims priority under 35 U.S.C. § 119 (a) to patent application No. 113101603 filed in Taiwan, R.O.C. on Jan. 15, 2024, the entire contents of which are hereby incorporated by reference.

### BACKGROUND

### Technical Field

A hinge module is provided, especially an electronic device and a hinge module with a multimedia assembly thereof.

### Related Art

For portable computers on the market, regardless of whether a speaker unit is arranged on a screen or a keyboard base, when the screen is turned on, a sound emitting direction of the speaker unit faces a user. However, when the screen is turned off, the sound emitting direction of the speaker unit is covered between the screen and the keyboard base, and consequently, a sound source cannot be effectively released.

### SUMMARY

In view of this, some embodiments provide an electronic device, including a first body, a second body, and a hinge module. The hinge module is arranged on one side of the first body. The hinge module includes a main shaft member, a transmission assembly, and a multimedia assembly. The main shaft member is pivotally connected to the first body and the second body. The transmission assembly is rotatably connected to the main shaft member. The multimedia assembly is connected to the transmission assembly. A rotation direction of the multimedia assembly is opposite to a rotation direction of the main shaft member, and the multimedia assembly is rotated relative to the first body and the second body through the main shaft member.

In some embodiments, the main shaft member includes a rotating rod, a first fixing plate, and a second fixing plate. The first fixing plate and the second fixing plate are located at one end of the rotating rod, and the first fixing plate and the second fixing plate are respectively connected to the first body and the second body.

In some embodiments, the rotating rod includes a first transmission member, the transmission assembly includes a second transmission member, the multimedia assembly includes a third transmission member, and the first transmission member is linked to the third transmission member through the second transmission member.

In some embodiments, the second body includes a first housing, the rotating rod is sleeved in the first housing, the transmission assembly includes a second housing, the second transmission member is arranged in the second housing, the multimedia assembly includes a third housing, the third transmission member is arranged in the third housing, and the first housing, the second housing, and the third housing are sequentially arranged in a direction;

In some embodiments, the first transmission member and the third transmission member respectively protrude toward the second transmission member and are engaged with the second transmission member.

In some embodiments, the first transmission member, the second transmission member, and the third transmission member are bevel gears.

In some embodiments, the multimedia assembly includes a multimedia element, the multimedia element is fixedly arranged in a housing, the third transmission member is located at one end of the multimedia element, and the multimedia element is rotated relative to the first body and the second body through the third transmission member.

In some embodiments, a plurality of sound emission holes are provided on an outer surface of the housing, the multimedia element includes a sound emission portion and faces the sound emission holes.

In some embodiments, a hinge module with a multimedia assembly is provided, where the hinge module includes a main shaft member, a transmission assembly, and a multimedia assembly. The main shaft member includes a first transmission member. The transmission assembly is connected to the first transmission member of the main shaft member through a second transmission member. The multimedia assembly includes a third transmission member and is connected to the second transmission member, the third transmission member being linked to the first transmission member through the second transmission member. A rotation direction of the third transmission member is different from a rotation direction of the first transmission member.

Based on the above, in some embodiments, a second rotation direction of the multimedia assembly is opposite to a first rotation direction of the main shaft member through a steering rotation function of the transmission assembly, so that the multimedia element can face the outside of the electronic device when the electronic device is in the folded state, and the multimedia element can face a user when the electronic device is in the unfolded state.

### BRIEF DESCRIPTION OF THE DRAWINGS

FIG. 1 is a schematic diagram of an appearance of an electronic device in a folded state according to some embodiments;

FIG. 2 is a schematic diagram of an appearance of an electronic device in an unfolded state according to some embodiments;

FIG. 3 is a schematic partial exploded view of an electronic device according to some embodiments;

FIG. 4A is a schematic partial diagram of an appearance of an electronic device in a folded state according to some embodiments;

FIG. 4B is a schematic partial diagram of an appearance of an electronic device in a folded state according to some embodiments;

FIG. 5 is a schematic partial diagram of an appearance of a back surface of an electronic device in an unfolded state according to some embodiments;

FIG. 6 is a schematic partial diagram of an appearance of a front surface of an electronic device in an unfolded state according to some embodiments;

FIG. 6A is a schematic partial diagram of an appearance of a front surface of an electronic device in an unfolded state according to some embodiments, where a multimedia element is in a state of a camera lens;

FIG. 7A is a schematic partial side view of a position marked A-A shown in FIG. 1, where an electronic device is in a folded state;

FIG. 7B is a schematic partial side view of an electronic device unfolded about 45 degrees from a perspective of FIG. 7A;

FIG. 7C is a schematic partial side view of an electronic device unfolded about 130 degrees from a perspective of FIG. 7A;

FIG. 8 is a schematic partial exploded view of an electronic device according to some embodiments;

FIG. 9 is a schematic partial diagram of an appearance of a back surface of an electronic device in an unfolded state according to some embodiments;

FIG. 10 is a schematic partial diagram of an appearance of a front surface of an electronic device in an unfolded state according to some embodiments;

FIG. 11 is a schematic partial exploded view of an electronic device according to some embodiments;

FIG. 12 is a schematic diagram of an appearance of a transmission assembly according to some embodiments;

FIG. 13 is a schematic partial diagram of an appearance of a back surface of an electronic device in an unfolded state according to some embodiments; and

FIG. 14 is a schematic partial diagram of an appearance of a front surface of an electronic device in an unfolded state according to some embodiments.

### DETAILED DESCRIPTION

The terms with regard to connection in the following embodiments, unless specifically stated as electrical connection, the connection may be a direct connection, or may be an indirect connection between physical components. To describe the disclosure more clearly, in the schematic diagrams provided in the disclosure, a first axis X is an X axis of a three-dimensional coordinate system, a second axis Y is a Y axis of the three-dimensional coordinate system, and a third axis Z is a Z axis of the three-dimensional coordinate system.

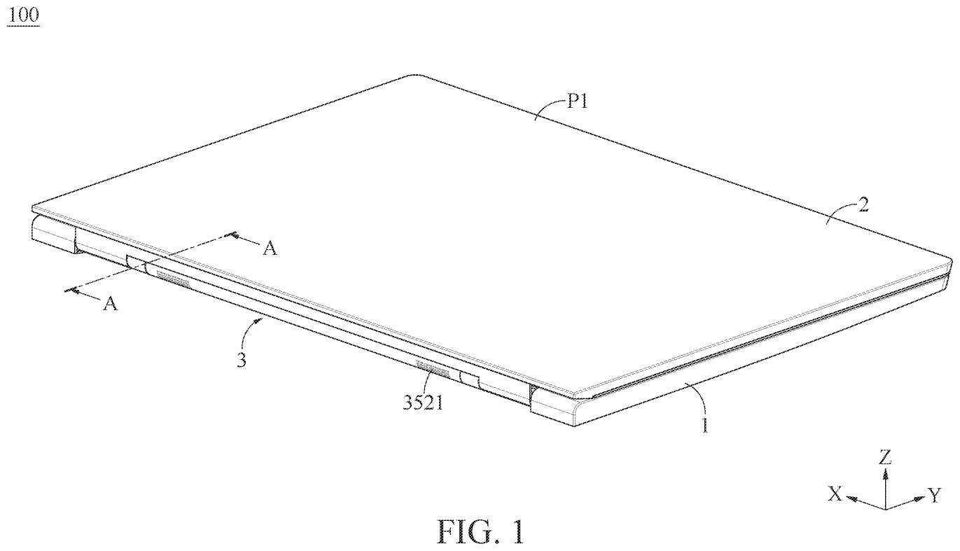

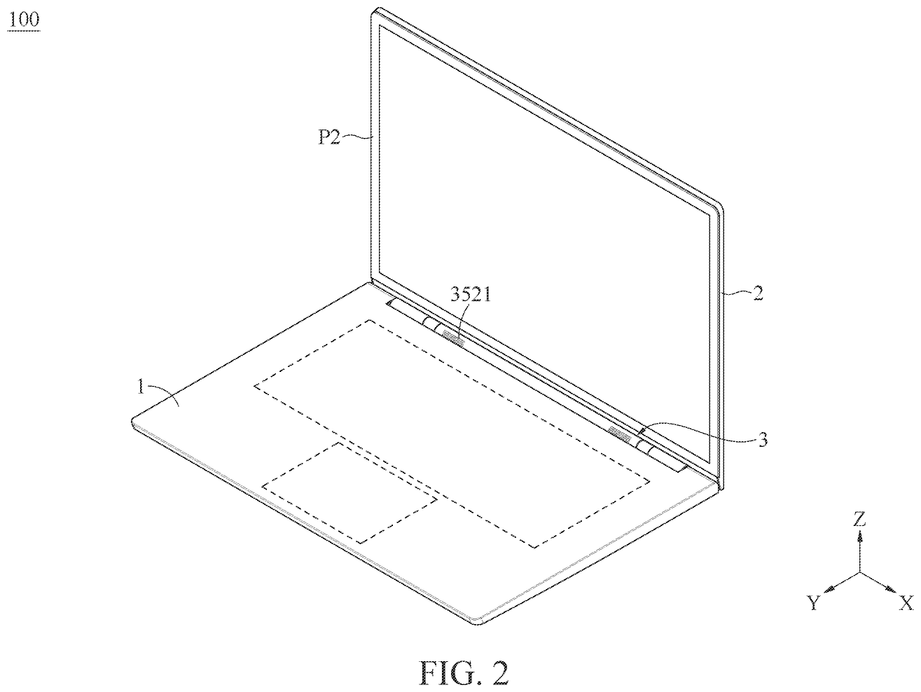

Refer to FIG. 1 and FIG. 2. FIG. 1 is a schematic diagram of an appearance of an electronic device 100 in a folded state P1. FIG. 2 is a schematic diagram of an appearance of an electronic device 100 in an unfolded state P2. The electronic device 100 includes a first body 1, a second body 2, and a hinge module 3. The first body 1 may be a key pad, and the second body 2 may be a screen. The hinge module 3 is arranged on one side of the first body 1. In some embodiments, the electronic device 100 may be a portable computer, but the disclosure is not limited thereto. In some embodiments, the hinge module 3 may be mounted in various electronic devices such as a foldable mobile phone, a tablet, or a watch.

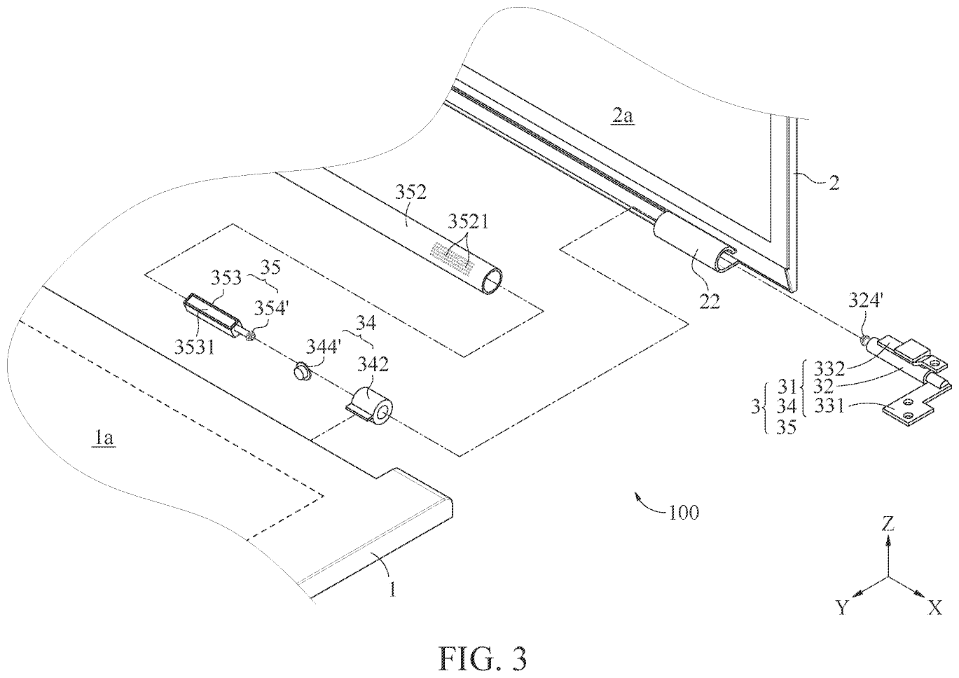

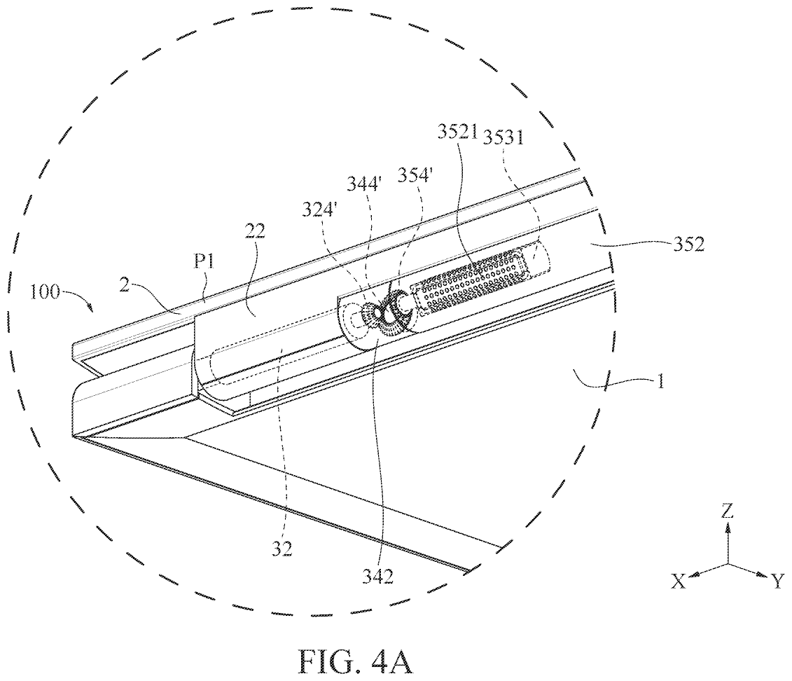

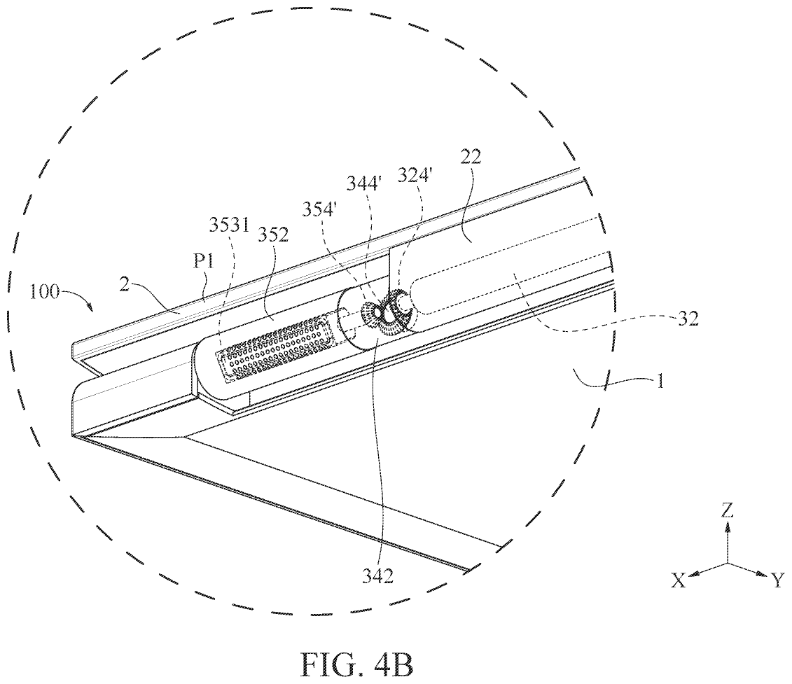

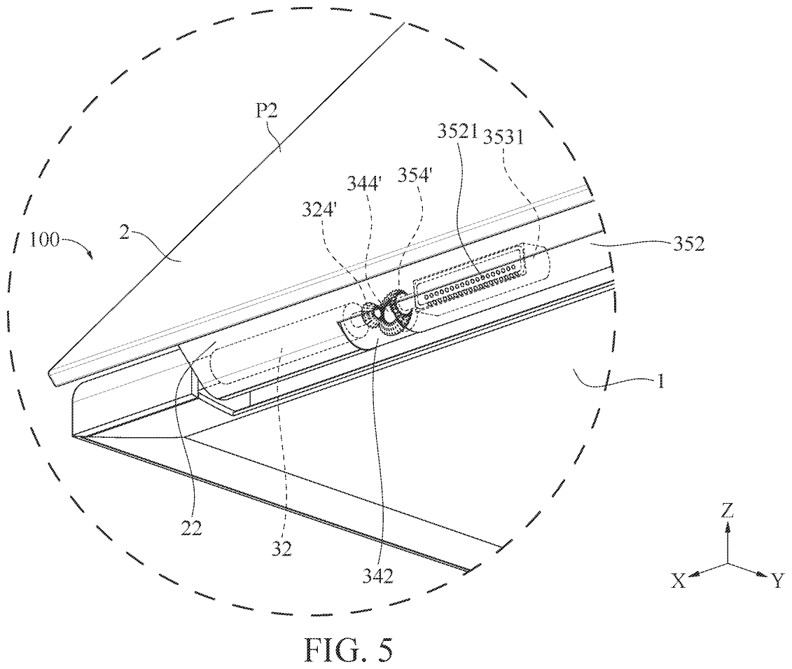

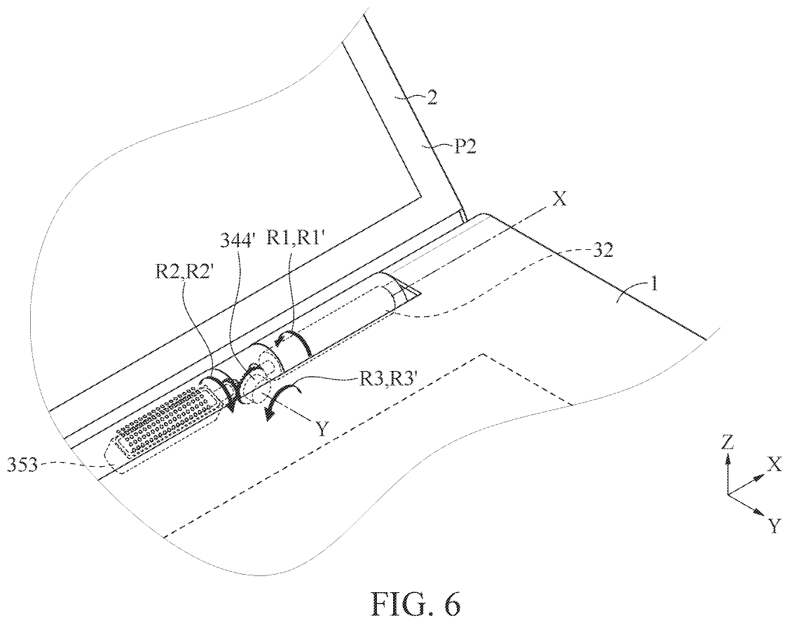

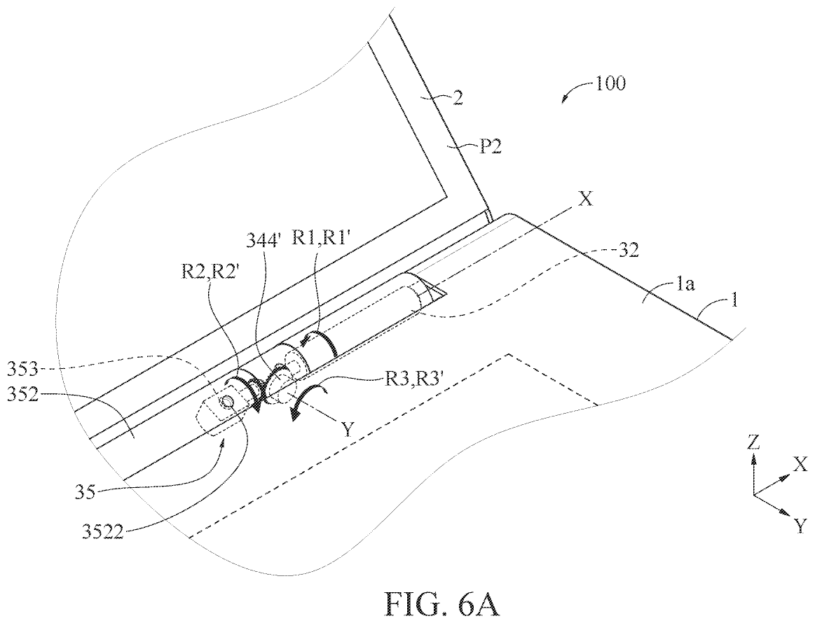

Refer to FIG. 3, FIG. 4A, FIG. 5, and FIG. 6. FIG. 3 is a schematic partial exploded view of an electronic device 100. FIG. 4A is a schematic partial diagram of an appearance of an electronic device 100 in a folded state P1. FIG. 5 is a schematic partial diagram of an appearance of a back surface of an electronic device 100 in an unfolded state P2. FIG. 6 is a schematic partial diagram of an appearance of a front surface of an electronic device 100 in an unfolded state P2. The hinge module 3 includes a main shaft member 31, a transmission assembly 34, and a multimedia assembly 35. The main shaft member 31 of the hinge module 3 is pivotally connected to the first body 1 or the second body 2, and is used to enable the second body 2 to rotate relative to the first body 1 with the main shaft member 31 as a pivot center. The second body 2 and the main shaft member 31 are used to rotate in first rotation directions R1 and R1′. The transmission assembly 34 is rotatably connected to the main shaft member 31. The multimedia assembly 35 is connected to the transmission assembly 34. The multimedia assembly 35 is used to rotate relative to the first body 1 and the second body 2 through the main shaft member 31. The multimedia assembly 35 is used to be driven by the transmission assembly 34 to rotate in second rotation directions R2 and R2′. The first rotation direction R1 is opposite to the second rotation direction R2, and the first rotation direction R1′ is opposite to the second rotation direction R2′. The first rotation direction R1 is a rotation direction for unfolding the same second bodies 2 relative to the first body 1, and the first rotation direction R1′ is a rotation direction for folding the same second bodies 2 relative to the first body 1. The disclosure is not limited thereto.

In some embodiments, when a user applies a force to the second body 2, and the second body 2 is unfolded relative to the first body 1 in the first rotation direction R1, the main shaft member 31 rotates in the first rotation direction R1, and the main shaft member 31 links the transmission assembly 34, so that the multimedia assembly 35 rotates in the second rotation direction R2. When the user applies a force to the second body 2, and the second body 2 is folded relative to the first body 1 in the first rotation direction R1′, the main shaft member 31 rotates in the first rotation direction R1′, and the main shaft member 31 links the transmission assembly 34, so that the multimedia assembly 35 rotates in the second rotation direction R2′. In this way, the second body 2 is operated to enable the multimedia assembly 35 to rotate opposite to the second body 2 through the main shaft member 31.

In some embodiments, the main shaft member 31 includes a rotating rod 32, a first fixing plate 331, and a second fixing plate 332, the first fixing plate 331 and the second fixing plate 332 are arranged at one end of the rotating rod 32, and the first fixing plate 331 and the second fixing plate 332 are respectively connected to the first body 1 and the second body 2. The second body 2 includes a first housing 22, and the rotating rod 32 is sleeved in the first housing 22. When the second body 2 rotates, the second fixing plate 332 of the second body 2 rotates relative to the first fixing plate 331 through the rotating rod 32, and the first housing 22 rotates synchronously with the rotating rod 32. In some embodiments, the first housing 22 may be arranged on the first body 1 and the rotating rod 32 is sleeved on the first housing 22, and the first body 1 may drive the rotating rod 32 to rotate. The disclosure is not limited thereto.

In some embodiments, the rotating rod 32 includes a first transmission member 324′, the transmission assembly 34 includes a second transmission member 344′, a second housing 342 is a hollow pipe and is fixedly arranged on the first body 1, and the second transmission member 344′ is arranged in the second housing 342. The first housing 22 and the second housing 342 are sequentially arranged in a direction of a first axis X.

In some embodiments, the multimedia assembly 35 includes a third housing 352, a multimedia element 353, and a third transmission member 354′. The third housing 352 is a hollow pipe, the multimedia element 353 is fixedly arranged in a housing 352 (using a same serial number as the third housing 352), the third transmission member 354′ is arranged in the third housing 352, the third transmission member 354′ is arranged at one end of the multimedia element 353, the multimedia element 353 is used to rotate relative to the first body 1 and the second body 2 through the third transmission member 354′, and the multimedia element 353 and the third housing 352 may simultaneously rotate in the second rotation directions R2 and R2′. The first housing 22, the second housing 342, and the third housing 352 are sequentially arranged in the direction of the first axis X. The multimedia element 353 may be, but is not limited to a speaker, a lens, or a microphone. In some embodiments, for example, the multimedia element 353 is a speaker, a plurality of sound emission holes 3521 are provided on an outer surface of the housing 352 (using the same serial number as the third housing 352), the multimedia element 353 includes a sound emission portion 3531, and the sound emission portion 3531 faces the sound emission holes 3521.

In some embodiments, the hinge module 3 may be divided into two groups which are respectively arranged on two sides of the first body 1 and are connected to the second body 2. In this design, the second body 2 may be stably unfolded or folded relative to the first body 1. In some embodiments, two multimedia elements 353 are respectively arranged on two sides of the third housing 352 and are respectively connected to two main shaft members 31. In some embodiments, the first transmission member 324′, the second transmission member 344′, and the third transmission member 354′ may be bevel gears. The disclosure is not limited thereto.

During assembly, the rotating rod 32 is sleeved in the first housing 22, and the first transmission member 324′ located at one end of the rotating rod 32 is arranged in the second housing 342 and is engaged with the second transmission member 344′. The multimedia element 353 is arranged in the third housing 352, and the third transmission member 354′ is arranged in the second housing 342 and is engaged with the second transmission member 344′. The first transmission member 324′ and the third transmission member 354′ respectively protrude toward the second transmission member 344′ from the rotating rod 32 and the multimedia element 353, are respectively engaged with two sides of the second transmission member 344′, and are arranged in the second housing 342. In some embodiments, when the second body 2 is unfolded from the folded state P1 relative to the first body 1, the second body 2 may drive, while rotating, the main shaft member 31 to rotate in the first rotation direction R1, so that the first transmission member 324′ of the main shaft member 31 rotates in the first rotation direction R1 and links the second transmission member 344′ to rotate in a third rotation direction R3, and the second transmission member 344′ drives the third transmission member 354′ of the multimedia assembly 35 to rotate in the second rotation direction R2. When the third transmission member 354′ rotates, the third transmission member 354′ may drive the multimedia element 353 and the third housing 352 to rotate synchronously. When the second body 2 is folded from the unfolded state P2 relative to the first body 1, the second body 2 drives the main shaft member 31 and the first transmission member 324′ to rotate in the first rotation direction R1′, the first transmission member 324′ drives the second transmission member 344′ to rotate in a third rotation direction R3′ and drives the third transmission member 354′ and the third housing 352 to rotate in the second rotation direction R2′. In this way, when the second body 2 moves, the third housing 352 rotates in the second rotation directions R2 and R2′ opposite to the first rotation directions R1 and R1′. In this design, when the electronic device 100 is in the unfolded state P2, the sound emission holes 3521 are close to a surface 1a of the first body 1; and when the electronic device 100 is in the folded state P1, the sound emission holes 3521 are away from the surface 1a of the first body 1. When the electronic device 100 is in the unfolded state P2, the sound emission holes 3521 may face the user, and when the electronic device 100 is in the folded state P1, the sound emission holes may be away from the first body 1 and the second body 2 and exposed to an external space.

In some embodiments, a ratio of an angle at which the main shaft member 31 rotates in the first rotation direction R1 to an angle at which the multimedia element 353 rotates in the second rotation direction R2 may be substantially 1:1, 1:2, or 2:1. In addition, the ratio of the rotation angle of the main shaft member 31 to the rotation angle of the multimedia element 353 may be adjusted according to gears of the first transmission member 324′, the second transmission member 344′, and the third transmission member 354′.

In some embodiments, an outer diameter of the second transmission member 344′ is greater than outer diameters of the first transmission member 324′ and the third transmission member 354′, and the first rotation directions R1 and R1′ of the first transmission member 324′ and the second rotation directions R2 and R2′ of the third transmission member 354′ respectively form an angle relative to the third rotation directions R3 and R3′ of the second transmission member 344′. In more detail, the first rotation directions R1 and R1′ and the second rotation directions R2 and R2′ are respectively perpendicular to the third rotation directions R3 and R3′.

Refer to FIG. 4B together. FIG. 4B is a schematic partial diagram of an appearance of an electronic device 100 in a folded state P1. In some embodiments, one end of the multimedia element 353 may be connected to the first fixing plate 331, the second fixing plate 332, and one rotation shaft (not shown in the figure). When the user rotates the second body 2, the rotation shaft drives the third transmission member 354′ of the multimedia element 353 and the third housing 352 to rotate synchronously, and the third transmission member 354′ drives the second transmission member 344′ and links the first transmission member 324′. Such configuration may also achieve effects of the foregoing embodiments. In other words, when the electronic device 100 is in the unfolded state P2, the sound emission holes 3521 of the multimedia element 353 may face the user, and when the electronic device 100 is in the folded state P1, the sound emission holes may be away from the first body 1 and the second body 2 and exposed to an external space. Details are not described herein again.

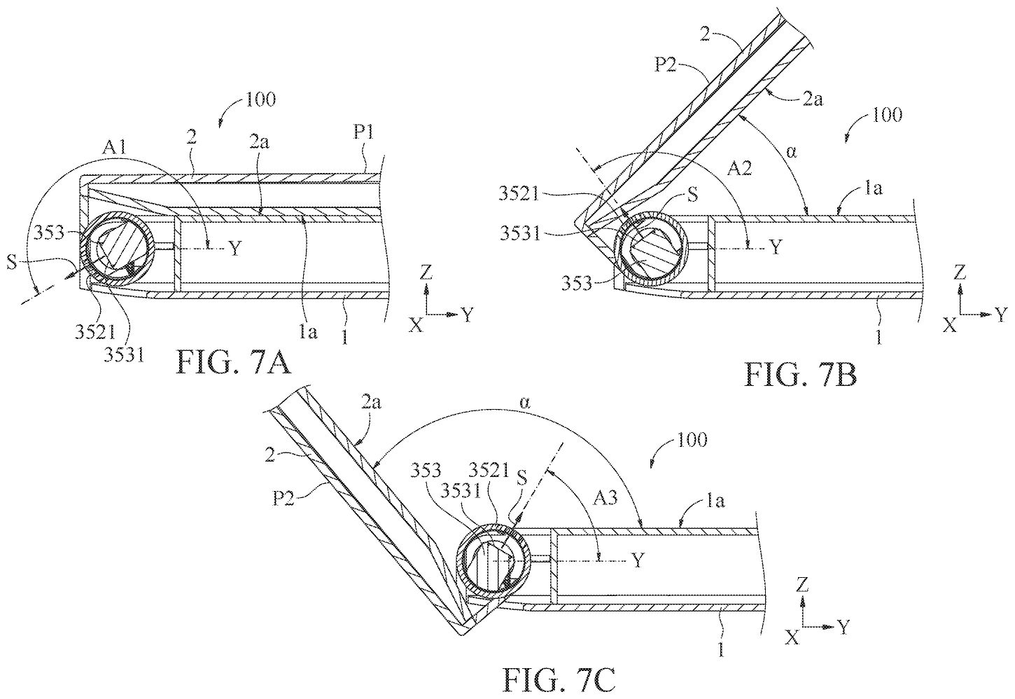

Refer to FIG. 3 and FIG. 7A. FIG. 7A is a schematic partial side view of a position marked A-A shown in FIG. 1, where an electronic device 100 is in a folded state P1. FIG. 7B is a schematic partial side view of an electronic device 100 unfolded about 45 degrees from a perspective of FIG. 7A. FIG. 7C is a schematic partial side view of an electronic device 100 unfolded about 130 degrees from a perspective of FIG. 7A. In some embodiments, when the user folds the second body 2 of the electronic device 100 relative to the first body 1, the sound emission portion 3531 of the multimedia element 353 is away from the surface 1a of the first body 1 and faces an external space of the first body 1, and a sound source of the sound emission portion 3531 emits sound toward the external space of the first body 1. In addition, the sound emission portion 3531 has a sound emission direction S, where there is a first angle A1 between the sound emission direction S and the surface 1a (a second axis Y) of the first body 1, and the first angle A1 is in a range of 150 degrees to 240 degrees.

Referring to FIG. 7B, in some embodiments, when the user unfolds the second body 2 of the electronic device 100 relative to the first body 1, there is an included angle α between the first body 1 and the second body 2. When the included angle α is about 45 degrees, the multimedia element 353 rotates in the second rotation direction R2 and enables the sound emission portion 3531 to face a surface 2a of the second body 2, and the sound source of the sound emission portion 3531 may rebound to the user through the first body 1 and the surface 2a of the second body 2. In this case, there is a second angle A2 between the sound emission direction S of the sound emission portion 3531 and the surface 1a (the second axis Y) of the first body 1, and the second angle A2 is in a range of 100 degrees to 190 degrees.

Referring to FIG. 7C, in some embodiments, when the included angle α is about 130 degrees, there is a third angle A3 between the sound emission direction S of the sound emission portion 3531 and the surface 1a (the second axis Y) of the first body 1, and the third angle A3 is in a range of 15 degrees to 105 degrees, for example, 45 degrees or 55 degrees, so that the sound emission portion 3531 is close to the surface 1a of the first body 1 and faces the user. In other words, the sound source of the sound emission portion 3531 emits sound toward the user.

In this way, when the electronic device 100 is in the unfolded state P2, the sound emission portion 3531 of the multimedia element 353 can face the user; or when the electronic device is in the folded state P1, the sound emission portion 3531 of the multimedia element 353 can face the outside of the electronic device 100, to effectively release the sound source, and provide good listening experience.

Refer to FIG. 6A. FIG. 6A is a schematic partial diagram of an appearance of a front surface of an electronic device 100 in an unfolded state P2 according to some embodiments, where a multimedia element 353 is in a state of a camera lens. In some embodiments, for example, the multimedia element 353 is a camera lens, the multimedia assembly 35 includes a housing 352 (with a same serial number as the third housing 352), the multimedia element 353, and an opening portion 3522. The opening portion 3522 is arranged on an outer surface of the housing 352, the multimedia element 353 is arranged in the housing 352, and the camera lens of the multimedia element 353 is exposed to an external space through the opening portion 3522, where the opening portion 3522 is used to be away from or close to the surface 1a of the first body 1 through the hinge module 3. The opening portion 3522 may face the user when the electronic device 100 is in the unfolded state P2, and shooting is performed through the camera lens of the multimedia element 353.

In some embodiments, the second body 2 rotates relative to the first body 1 to be in the folded state P1 or the unfolded state P2, the opening portion 3522 of the multimedia element 353 is away from the surface 1a of the first body 1 when the second body 2 is in the folded state P1, and the opening portion 3522 of the multimedia element 353 is close to the surface 1a of the first body 1 when the second body 2 is in the unfolded state P2. There is an included angle between the opening portion 3522 of the multimedia element 353 and the surface 1a of the first body 1 in the unfolded state P2. The included angle is in a range of 100 degrees to 190 degrees, and the included angle is the same as the second angle A2 in the foregoing embodiments. Details are not described herein again.

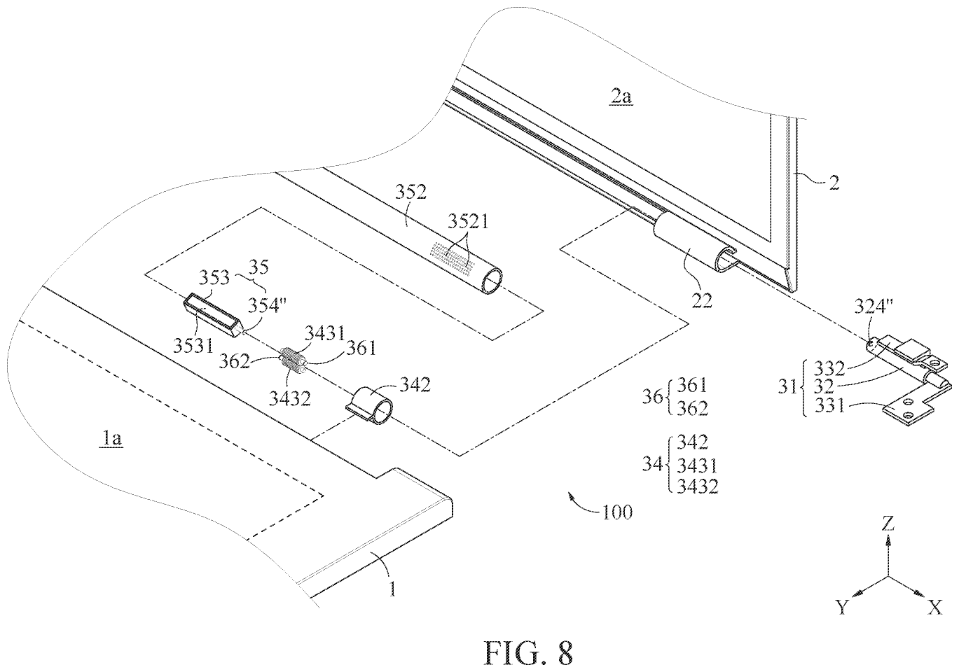

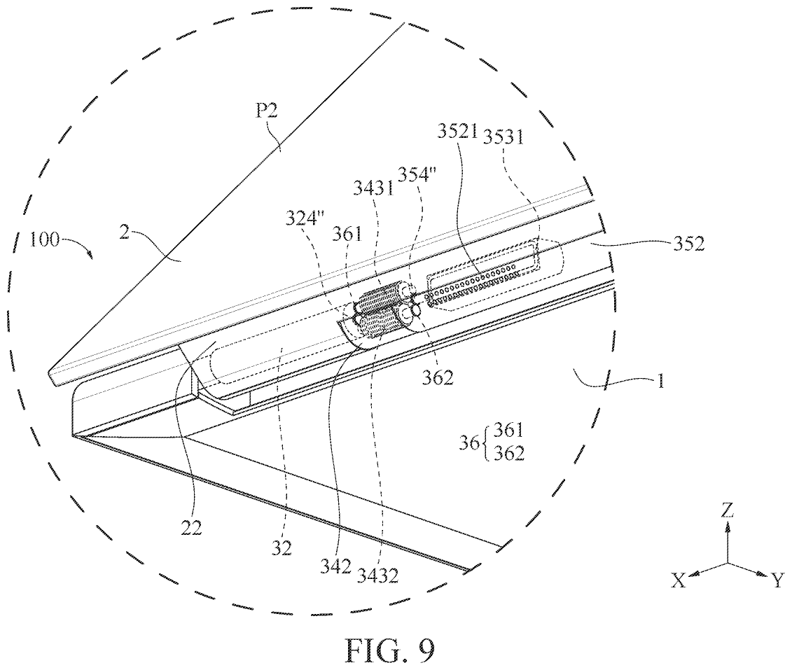

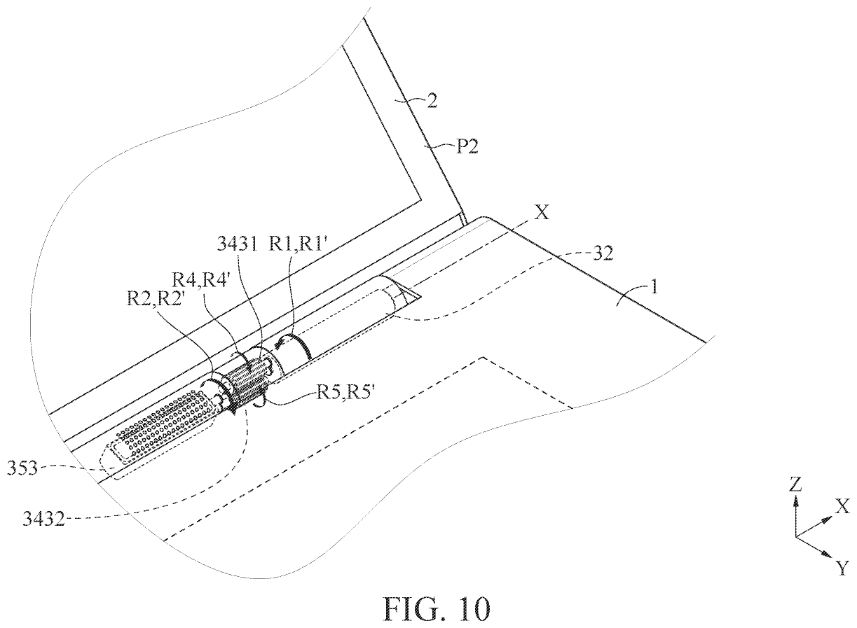

Refer to FIG. 8 to FIG. 10. FIG. 8 is a schematic partial exploded view of an electronic device 100. FIG. 9 is a schematic partial diagram of an appearance of a back surface of an electronic device 100 in an unfolded state. FIG. 10 is a schematic partial diagram of an appearance of a front surface of an electronic device 100 in an unfolded state. In some embodiments, one end of the rotating rod 32 is connected to the first fixing plate 331 and the second fixing plate 332, and a first transmission member 324″ is arranged at the other end. The transmission assembly 34 includes a second housing 342, transmission rods 3431 and 3432 in the second housing 342, and second transmission members 361 and 362 engaged with each other. The transmission rod 3431 and the transmission rod 3432 are engaged with textures, and the transmission rod 3431 and the transmission rod 3432 are linked with each other. The second transmission members 361 and 362 respectively have the transmission rods 3431 and 3432, where the transmission rod 3431 of one second transmission member 361 is engaged with the transmission rod 3432 of the other second transmission member 362. The second transmission members 361 and 362 are respectively arranged on the transmission rods 3431 and 3432. The second transmission member 361 extends in the direction of the first axis X from the transmission rod 3431 toward the main shaft member 31 and is engaged with the first transmission member 324″. The second transmission member 362 extends in a-X direction opposite to the direction of the first axis X from the transmission rod 3432 toward the multimedia assembly 35 and is engaged with a third transmission member 354″. In some embodiments, outer diameters of the transmission rods 3431 and 3432 are greater than outer diameters of the second transmission members 361 and 362. In some embodiments, the transmission rods 3431 and 3432 are engaged with each other through gears. The disclosure is not limited thereto.

In some embodiments, the multimedia assembly 35 includes the third housing 352, the multimedia element 353, and the third transmission member 354″. The third housing 352 is a hollow pipe. The multimedia element 353 is fixedly arranged in the third housing 352. One end of the third transmission member 354″ is connected to the second transmission member 362. The other end of the third transmission member 354″ is connected to the multimedia element 353, and the multimedia element 353 and the third housing 352 may rotate simultaneously in the second rotation directions R2 and R2′. The first housing 22, the second housing 342, and the third housing 352 are sequentially arranged in the direction of the first axis X.

During assembly, the rotating rod 32 is sleeved in the first housing 22, and the first transmission member 324″ located at one end of the rotating rod 32 is arranged in the second housing 342 and is engaged with the second transmission member 361. The multimedia element 353 is arranged in the third housing 352, and the third transmission member 354″ is arranged in the second housing 342 and is engaged with the second transmission member 362.

In some embodiments, when the second body 2 is unfolded from the folded state P1 relative to the first body 1, the second body 2 may drive, while rotating, the main shaft member 31 to rotate in the first rotation direction R1, so that the first transmission member 324″ of the main shaft member 31 rotates in the first rotation direction R1, links the second transmission member 361 to rotate in a fourth rotation direction R4, and drives the transmission rod 3431 to rotate in the fourth rotation direction R4. Since the transmission rod 3431 and the transmission rod 3432 are linked, the transmission rod 3431 drives the transmission rod 3432 to rotate in a fifth rotation direction R5, so that the second transmission member 362 simultaneously rotates in the fifth rotation direction R5 and drives the third transmission member 354″ of the multimedia assembly 35 to rotate in the second rotation direction R2. When the third transmission member 354″ rotates, the third transmission member 354″ may drive the multimedia element 353 and the third housing 352 to synchronously rotate. When the second body 2 is folded from the unfolded state P2 relative to the first body 1, the second body 2 drives the main shaft member 31 and the first transmission member 324″ to rotate in the first rotation direction R1′, the first transmission member 324″ drives the second transmission member 361 to rotate in a fourth rotation direction R4′, and the second transmission member 361 simultaneously drives the transmission rod 3431 to rotate in the fourth rotation direction R4′. The transmission rod 3431 drives the transmission rod 3432 to rotate in a fifth rotation direction R5′, and simultaneously drives the second transmission member 362 to rotate in the fifth rotation direction R5′. The second transmission member 362 drives the third transmission member 354″ and the third housing 352 to rotate in the second rotation direction R2′. In this way, when the second body 2 moves, the third housing 352 rotates in the second rotation directions R2 and R2′ opposite to the first rotation directions R1 and R1′. The rest configurations are the same as those of the foregoing embodiments. Details are not described herein again. In some embodiments, the first rotation directions R1 and R1′ are respectively the same as the fifth rotation directions R5 and R5′, and the second rotation directions R2 and R2′ are respectively the same as the fourth rotation directions R4 and R4′. The first rotation directions R1 and R1′ and the second rotation directions R2 and R2′ are respectively at the same rotation directions to the fourth rotation directions R4 and R4′ and the fifth rotation directions R5 and R5′.

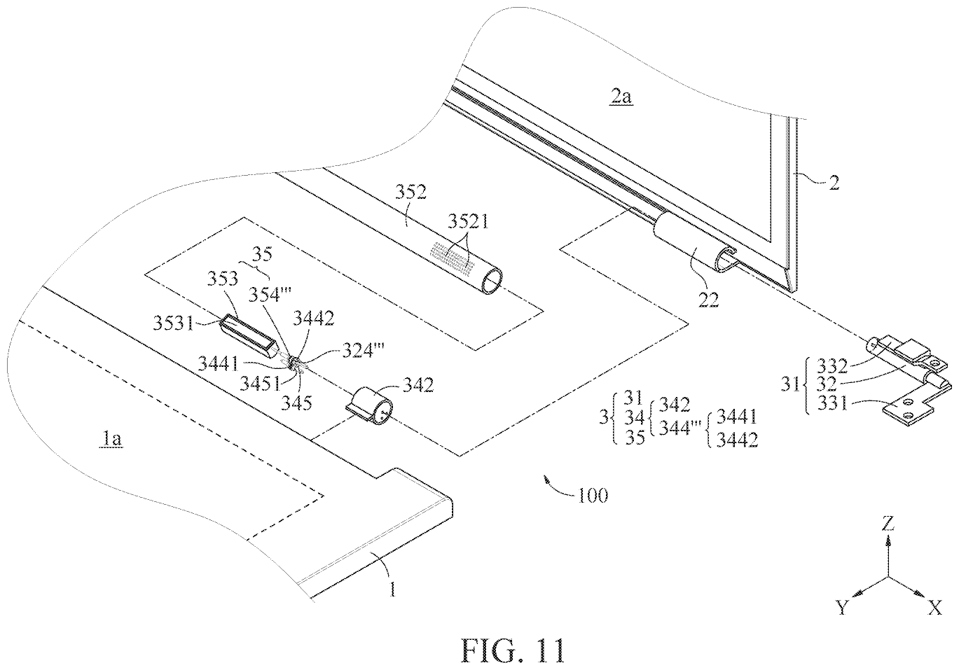

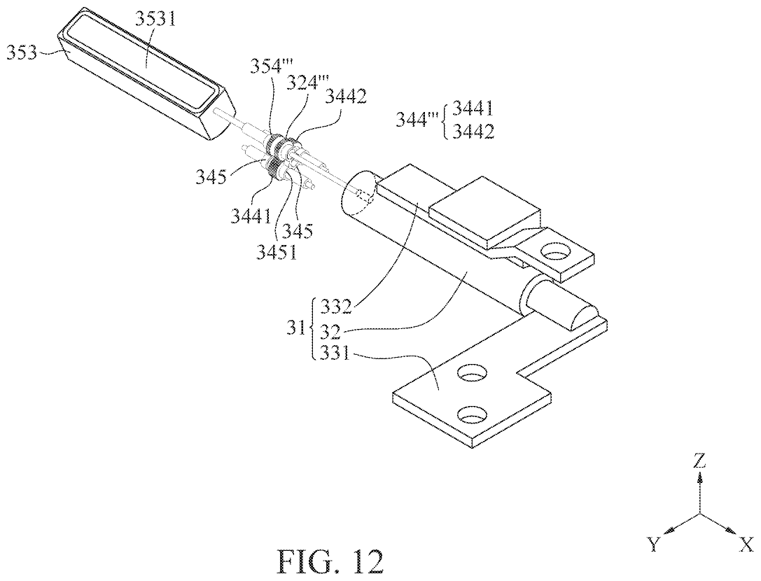

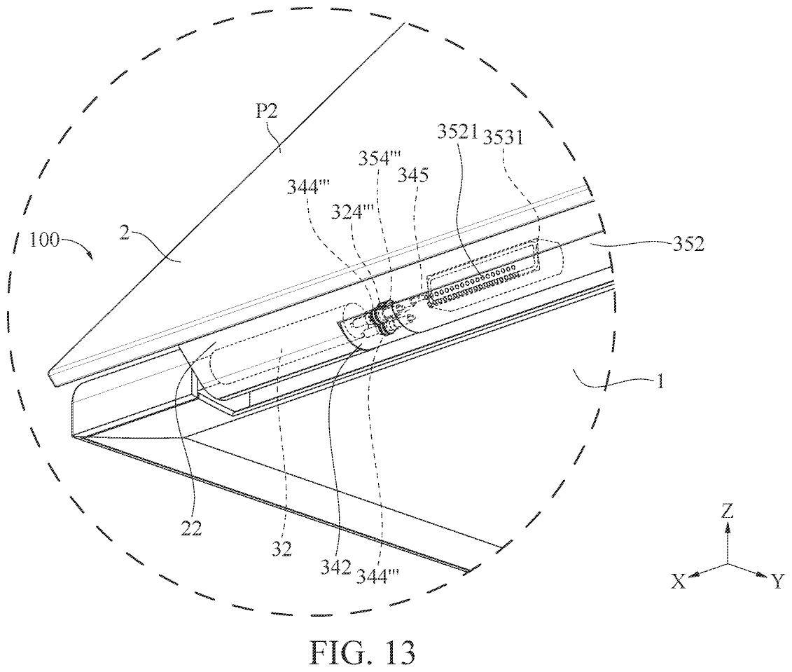

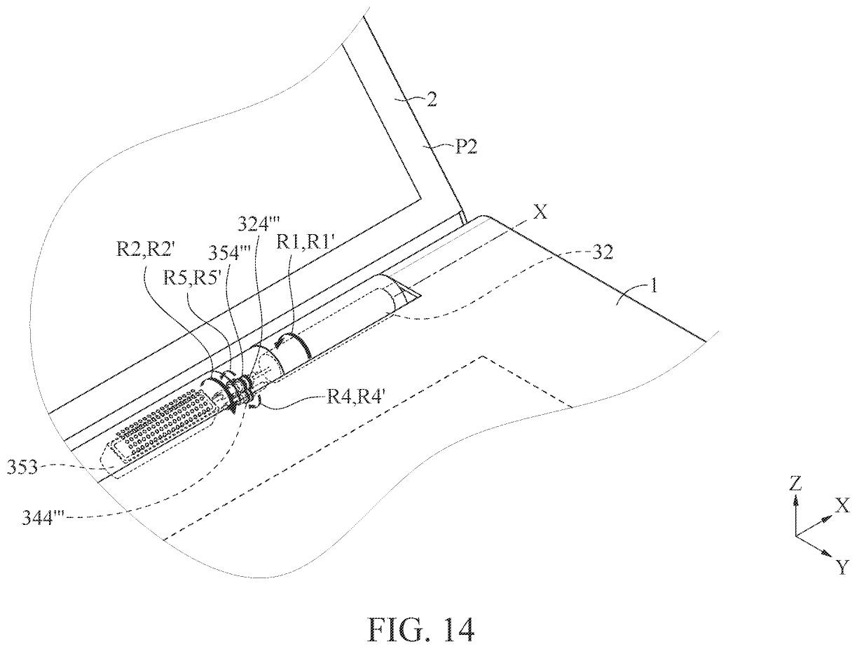

Refer to FIG. 11 to FIG. 14. FIG. 11 is a schematic partial exploded view of an electronic device 100. FIG. 12 is a schematic diagram of an appearance of a transmission assembly 34. FIG. 13 is a schematic partial diagram of an appearance of a back surface of an electronic device 100 in an unfolded state P2. FIG. 14 is a schematic partial diagram of an appearance of a front surface of an electronic device 100 in an unfolded state P2. In some embodiments, one end of the rotating rod 32 is connected to the first fixing plate 331 and the second fixing plate 332, and a first transmission member 324″ is arranged at the other end. The transmission assembly 34 includes the second housing 342 and a plurality of second transmission members 344″ (including 3441 and 3442) in the second housing 342. Outer diameters of the second transmission members 344″ are greater than an outer diameter of the first transmission member 324″. The first transmission member 324″ is engaged with the second transmission member 3441, and the second transmission member 3441 is engaged with the second transmission member 3442.

In some embodiments, the multimedia assembly 35 includes the third housing 352, the multimedia element 353, and a third transmission member 354″. The third housing 352 is a hollow pipe. The multimedia element 353 is fixedly arranged in the third housing 352. One end of the third transmission member 354″ is connected to the second transmission member 3442, so that the second transmission member 3442 is engaged with the third transmission member 354″, and the other end is connected to the multimedia element 353. The multimedia element 353 and the third housing 352 may simultaneously rotate in the second rotation directions R2 and R2′. The first housing 22, the second housing 342, and the third housing 352 are sequentially arranged in the direction of the first axis X.

During assembly, the rotating rod 32 is sleeved in the first housing 22, and the first transmission member 324″ located at one end of the rotating rod 32 is arranged in the second housing 342 and is engaged with the second transmission member 3441. The third transmission member 354″ is arranged in the second housing 342 and is engaged with the second transmission member 3442. The third transmission member 354′″ and the first transmission member 324″ are coaxially arranged in the direction of the first axis X. The first transmission member 324′″ and the third transmission member 354″ respectively protrude from the main shaft member 31 and the multimedia element 353 toward the second transmission members 344′ and are respectively engaged with the second transmission members 3441 and 3442 of the second transmission members 344″

In some embodiments, the transmission assembly 34 includes a bracket 345. The bracket 345 is provided with a plurality of shaft holes 3451. The first transmission member 324″, the second transmission members 344″ (including 3441 and 3442), and the third transmission member 354′ are respectively pivotally connected to the shaft holes 3451. In some embodiments, the first transmission member 324″ is sleeved on the third transmission member 354″, and both the first transmission member 324″ and the third transmission member 354″ are sleeved in one shaft hole 3451.

In some embodiments, when the second body 2 is unfolded from the folded state P1 relative to the first body 1, the second body 2 may drive, while rotating, the main shaft member 31 to rotate in the first rotation direction R1, so that the first transmission member 324″ of the main shaft member 31 rotates in the first rotation direction R1 and links the second transmission member 3441 and the second transmission member 3442 to respectively rotate in the fourth rotation direction R4 and the fifth rotation direction R5, and the second transmission member 3442 drives the third transmission member 354″ of the multimedia assembly 35 to rotate in the second rotation direction R2. When the third transmission member 354″ rotates, the third transmission member 354″ may drive the multimedia element 353 and the third housing 352 to rotate synchronously. When the second body 2 is folded from the unfolded state P2 relative to the first body 1, the second body 2 drives the main shaft member 31 and the first transmission member 324′″ to rotate in the first rotation direction R1′, the first transmission member 324″ drives the second transmission member 3441 and the second transmission member 3442 to rotate in the fourth rotation direction R4′ and the fifth rotation direction R5′ and drives the third transmission member 354″ and the third housing 352 to rotate in the second rotation direction R2′. In this way, when the second body 2 moves, the third housing 352 rotates in the second rotation directions R2 and R2′ opposite to the first rotation directions R1 and R1′. The rest configurations are the same as those of the foregoing embodiments. Details are not described herein again.

In some embodiments, the first rotation directions R1 and R1′ are respectively opposite to the fourth rotation directions R4 and R4′, and the second rotation directions R2 and R2′ are respectively opposite to the fifth rotation directions R5 and R5′. The first rotation directions R1 and R1′ and the second rotation directions R2 and R2′ are respectively at the same rotation direction to the fourth rotation directions R4 and R4′ and the fifth rotation directions R5 and R5′.

Based on the above, in some embodiments, a second rotation direction of the multimedia assembly is opposite to a first rotation direction of the main shaft member through a steering rotation function of the transmission assembly, so that the multimedia element can face the outside of the electronic device when the electronic device is in the folded state, and the multimedia element can face a user when the electronic device is in the unfolded state.

What is claimed is:

1. An electronic device, comprising:
a first body;
a second body; and
a hinge module, arranged on one side of the first body, wherein the hinge module comprises:
a main shaft member, pivotally connected to the first body and the second body;
a transmission assembly, rotatably connected to the main shaft member; and
a multimedia assembly, connected to the transmission assembly, wherein
a rotation direction of the multimedia assembly is opposite to a rotation direction of the main shaft member, and the multimedia assembly is rotated relative to the first body and the second body through the main shaft member.

2. The electronic device according to claim 1, wherein the main shaft member comprises a rotating rod, a first fixing plate, and a second fixing plate, the first fixing plate and the second fixing plate being located at one end of the rotating rod, and the first fixing plate and the second fixing plate being respectively connected to the first body and the second body.

3. The electronic device according to claim 2, wherein the rotating rod comprises a first transmission member, the transmission assembly comprises a second transmission member, the multimedia assembly comprises a third transmission member, and the first transmission member is linked to the third transmission member through the second transmission member.

4. The electronic device according to claim 3, wherein the second body comprises a first housing, the rotating rod is sleeved in the first housing, the transmission assembly comprises a second housing, the second transmission member is arranged in the second housing, the multimedia assembly comprises a third housing, the third transmission member is arranged in the third housing, and the first housing, the second housing, and the third housing are sequentially arranged in a direction.

5. The electronic device according to claim 3, wherein the first transmission member and the third transmission member respectively protrude toward the second transmission member and are engaged with the second transmission member.

6. The electronic device according to claim 3, wherein the first transmission member, the second transmission member, and the third transmission member are bevel gears.

7. The electronic device according to claim 3, wherein the multimedia assembly comprises a multimedia element, the multimedia element is fixedly arranged in a housing, the third transmission member is located at one end of the multimedia element, and the multimedia element is rotated relative to the first body and the second body through the third transmission member.

8. The electronic device according to claim 7, wherein a plurality of sound emission holes are provided on an outer surface of the housing, and the multimedia element comprises a sound emission portion and faces the sound emission holes.

9. The electronic device according to claim 2, wherein the multimedia assembly comprises a housing, a multimedia element, and an opening portion, the opening portion is located on an outer surface of the housing, the multimedia element is arranged in the housing, the multimedia element is exposed to an external space through the opening portion, and the opening portion is rotated away from or close to a surface of the first body through the hinge module.

10. The electronic device according to claim 9, wherein the second body rotates relative to the first body to be in a folded state or an unfolded state, the opening portion of the multimedia element is away from the surface of the first body when the second body is in the folded state, and the opening portion of the multimedia element is close to the surface of the first body when the second body is in the unfolded state.

11. The electronic device according to claim 10, wherein there is an included angle between the opening portion of the multimedia element and the surface of the first body in the unfolded state, the included angle being in a range of 100 degrees to 190 degrees.

12. The electronic device according to claim 2, wherein the rotating rod comprises a first transmission member, the transmission assembly comprises two second transmission members engaged with each other, the multimedia assembly comprises a third transmission member, the first transmission member is connected to one of the second transmission members, the third transmission member is connected to the other second transmission member, and the first transmission member is linked to the third transmission member through the second transmission member.

13. The electronic device according to claim 12, wherein the two second transmission members each have a transmission rod, the transmission rod of one second transmission member being engaged with the transmission rod of the other second transmission member.

14. The electronic device according to claim 12, wherein the transmission assembly comprises a bracket, the bracket comprises a plurality of shaft holes, and the shaft holes are pivotally connected to the first transmission member, the second transmission members, and the third transmission member.

15. The electronic device according to claim 1, wherein the main shaft member comprises a rotating rod, a first fixing plate, and a second fixing plate, the first fixing plate and the second fixing plate being located at one end of the rotating rod, and the first fixing plate and the second fixing plate being respectively connected to the first body and the second body; the rotating rod comprises a first transmission member, the transmission assembly comprises a second transmission member, the multimedia assembly comprises a third transmission member, and the first transmission member is linked to the third transmission member through the second transmission member; the second body comprises a first housing, the rotating rod is sleeved in the first housing, the transmission assembly comprises a second housing, the second transmission member is arranged in the second housing, the multimedia assembly comprises a third housing, the third transmission member is arranged in the third housing, and the first housing, the second housing, and the third housing are sequentially arranged in a direction; the first transmission member and the third transmission member respectively protrude toward the second transmission member and are engaged with the second transmission member; the first transmission member, the second transmission member, and the third transmission member are bevel gears; the multimedia assembly comprises a multimedia element, the multimedia element is fixedly arranged in a housing, the third transmission member is located at one end of the multimedia element, and the multimedia element is rotated relative to the first body and the second body through the third transmission member; and a plurality of sound emission holes are provided on an outer surface of the housing, and the multimedia element comprises a sound emission portion and faces the sound emission holes.

16. A hinge module with a multimedia assembly, comprising:
a main shaft member, comprising a first transmission member;
a transmission assembly, connected to the first transmission member of the main shaft member through a second transmission member; and
a multimedia assembly, comprising a third transmission member and connected to the second transmission member, the third transmission member being linked to the first transmission member through the second transmission member, wherein
a rotation direction of the third transmission member is different from a rotation direction of the first transmission member.

17. The hinge module according to claim 16, wherein the multimedia assembly comprises a housing, a multimedia element, and an opening portion, the opening portion is located on an outer surface of the housing, the multimedia element is arranged in the housing, the multimedia element is exposed to an external space through the opening portion, and the housing is rotated relative to the main shaft member through the third transmission member.

18. The hinge module according to claim 16, wherein the transmission assembly comprises two second transmission members engaged with each other, the first transmission member is connected to one of the second transmission members, the third transmission member is connected to the other second transmission member, and the first transmission member is linked to the third transmission member through the second transmission member.

19. The hinge module according to claim 18, wherein the two second transmission members each have a transmission rod, the transmission rod of one second transmission member being engaged with the transmission rod of the other second transmission member.

20. The hinge module according to claim 16, wherein the first transmission member and the third transmission member respectively protrude toward the second transmission member and are engaged with the second transmission member.
